(19) United States
(12) Patent Application Publication
(10) Pub. No.: US 2020/0162341 A1
(43) Pub. Date: May 21, 2020

(54) PEER COMPARISON BY A NETWORK ASSURANCE SERVICE USING NETWORK ENTITY CLUSTERS

(71) Applicant: Cisco Technology, Inc., San Jose, CA (US)

(72) Inventors: Jean-Philippe Vasseur, Saint Martin D'uriage (FR); Grégory Mermoud, Veyras, VS (CH); Erwan Barry Tarik Zerhouni, Zürich (CH); Santosh Ghanshyam Pandey, Fremont, CA (US)

(21) Appl. No.: 16/196,070

(22) Filed: Nov. 20, 2018

(51) Int. Cl. H04L 12/24; H04L 12/26; H04L 29/08; G06N 20/00

(52) U.S. Cl. CPC H04L 41/16; H04L 43/08; G06N 20/00; H04L 67/104; H04L 41/147

(57) ABSTRACT

In one embodiment, a network assurance service that monitors a plurality of networks obtains characteristic data regarding network entities deployed in the plurality of networks. The network assurance service assigns the network entities to entity clusters by applying a clustering mechanism to the characteristic data regarding the network entities. The network assurance service generates, for each of the entity clusters, a training dataset using the characteristic data for the network entities assigned to that cluster. The network assurance service uses, for each of the entity clusters, the training datasets for an entity cluster to train a machine learning-based model that models the behavior of that entity cluster.

### TECHNICAL FIELD

The present disclosure relates generally to computer networks, and, more particularly, to a network assurance service that performs peer comparisons using user profile clusters.

### BACKGROUND

Networks are large-scale distributed systems governed by complex dynamics and very large number of parameters. In general, network assurance involves applying analytics to captured network information, to assess the health of the network. For example, a network assurance system may track and assess metrics such as available bandwidth, packet loss, jitter, and the like, to ensure that the experiences of users of the network are not impinged. However, as networks continue to evolve, so too will the number of applications present in a given network, as well as the number of metrics available from the network.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example network assurance system;

FIG. 4 illustrates an example architecture for a network assurance service; and

FIG. 5 illustrates an example simplified procedure for using network entity clusters to train behavioral models for a network assurance service.

### DESCRIPTION OF EXAMPLE EMBODIMENTS

### Overview

According to one or more embodiments of the disclosure, a network assurance service that monitors a plurality of networks obtains characteristic data regarding network entities deployed in the plurality of networks. The network assurance service assigns the network entities to entity clusters by applying a clustering mechanism to the characteristic data regarding the network entities. The network assurance service generates, for each of the entity clusters, a training dataset using the characteristic data for the network entities assigned to that cluster. The network assurance service uses, for each of the entity clusters, the training datasets for an entity cluster to train a machine learning-based model that models the behavior of that entity cluster.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

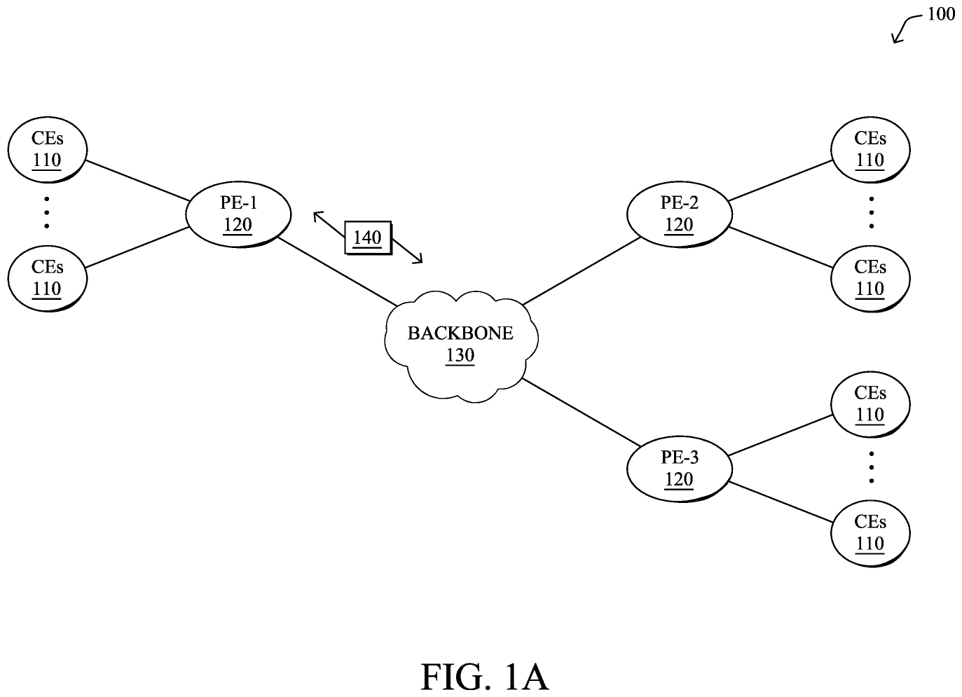

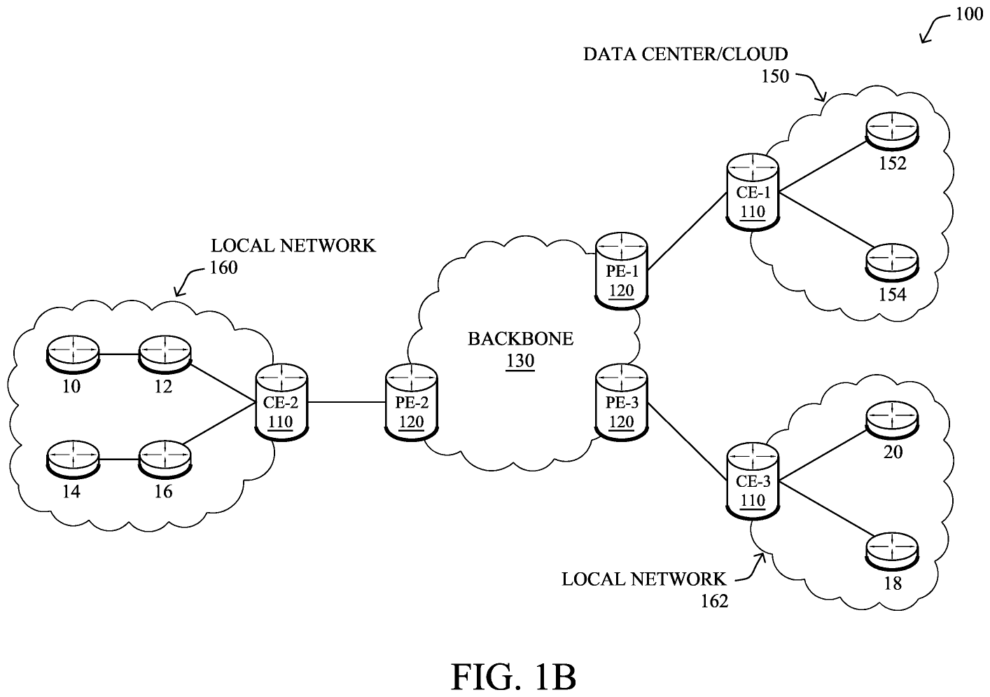

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers), with potentially a backup link (e.g., a 3G/4G/LTE connection). A site of type B may itself be of different types:

2a.) Site Type B1: a site connected to the network using two MPLS VPN links (e.g., from different Service Providers), with potentially a backup link (e.g., a 3G/4G/LTE connection).

2b.) Site Type B2: a site connected to the network using one MPLS VPN link and one link connected to the public Internet, with potentially a backup link (e.g., a 3G/4G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local is networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an authentication, authorization and accounting (AAA) server, an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

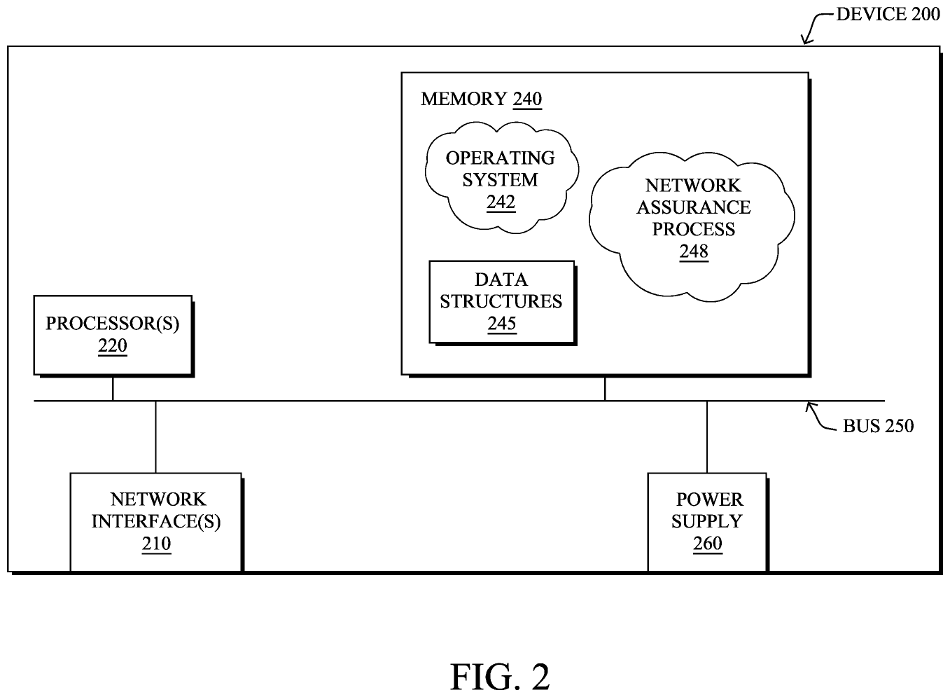

FIG. 2 is a schematic block diagram of an example node/device 200 that may be used with one or more embodiments described herein, e.g., as any of the computing devices shown in FIGS. 1A-1B, particularly the PE routers 120, CE routers 110, nodes/device 10-20 servers 152-154 (e.g., a network controller located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250 and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a network assurance process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Network assurance process 248 includes computer executable instructions that, when executed by processor(s) 220, cause device 200 to perform network assurance functions as part of a network assurance infrastructure within the network. In general, network assurance refers to the branch of networking concerned with ensuring that the network provides an acceptable level of quality in terms of the user experience. For example, in the case of a user participating in a videoconference, the infrastructure may enforce one or more network policies regarding the videoconference traffic, as well as monitor the state of the network, to ensure that the user does not perceive potential issues in the network (e.g., the video seen by the user freezes, the audio output drops, etc.).

In some embodiments, network assurance process 248 may use any number of predefined health status rules, to enforce policies and to monitor the health of the network, in view of the observed conditions of the network. For example, one rule may be related to maintaining the service usage peak on a weekly and/or daily basis and specify that if the monitored usage variable exceeds more than 10% of the per day peak from the current week AND more than 10% of the last four weekly peaks, an insight alert should be triggered and sent to a user interface.

Another example of a health status rule may involve client transition events in a wireless network. In such cases, whenever there is a failure in any of the transition events, the wireless controller may send a reason_code to the assurance system. To evaluate a rule regarding these conditions, the network assurance system may then group 150 failures into different “buckets” (e.g., Association, Authentication, Mobility, DHCP, WebAuth, Configuration, Infra, Delete, De-Authorization) and continue to increment these counters per service set identifier (SSID), while performing averaging every five minutes and hourly. The system may also maintain a client association request count per SSID every five minutes and hourly, as well. To trigger the rule, the system may evaluate whether the error count in any bucket has exceeded 20% of the total client association request count for one hour.

In various embodiments, network assurance process 248 may also utilize machine learning techniques, to enforce policies and to monitor the health of the network. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, network assurance process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that network assurance process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) ANNs (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

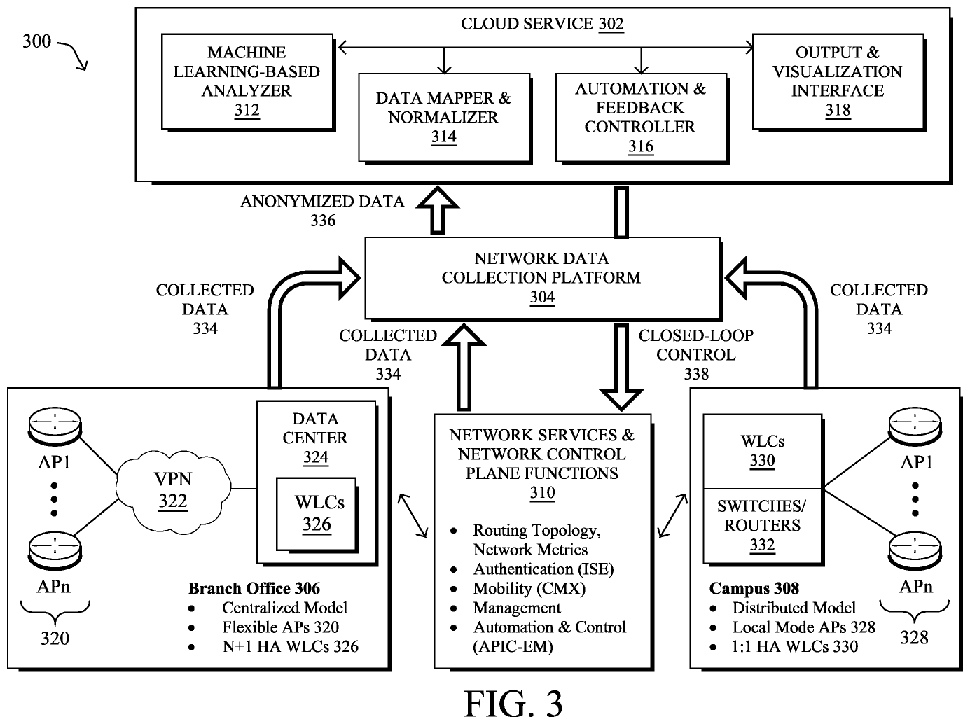

FIG. 3 illustrates an example network assurance system 300, according to various embodiments. As shown, at the core of network assurance system 300 may be a cloud service 302 that leverages machine learning in support of cognitive analytics for the network, predictive analytics (e.g., models used to predict user experience, etc.), troubleshooting with root cause analysis, and/or trending analysis for capacity planning. Generally, architecture 300 may support both wireless and wired network, as well as LLNs/IoT networks.

In various embodiments, cloud service 302 may oversee the operations of the network of an entity (e.g., a company, school, etc.) that includes any number of local networks. For example, cloud service 302 may oversee the operations of the local networks of any number of branch offices (e.g., branch office 306) and/or campuses (e.g., campus 308) that may be associated with the entity. Data collection from the various local networks/locations may be performed by a network data collection platform 304 that communicates with both cloud service 302 and the monitored network of the entity.

The network of branch office 306 may include any number of wireless access points 320 (e.g., a first access point AP1 through nth access point, APn) through which endpoint nodes may connect. Access points 320 may, in turn, be in communication with any number of wireless LAN controllers (WLCs) 326 (e.g., supervisory devices that provide control over APs) located in a centralized datacenter 324. For example, access points 320 may communicate with WLCs 326 via a VPN 322 and network data collection platform 304 may, in turn, communicate with the devices in datacenter 324 to retrieve the corresponding network feature data from access points 320, WLCs 326, etc. In such a centralized model, access points 320 may be flexible access points and WLCs 326 may be N+1 high availability (HA) WLCs, by way of example.

Conversely, the local network of campus 308 may instead use any number of access points 328 (e.g., a first access point AP1 through nth access point APm) that provide connectivity to endpoint nodes, in a decentralized manner. Notably, instead of maintaining a centralized datacenter, access points 328 may instead be connected to distributed WLCs 330 and switches/routers 332. For example, WLCs 330 may be 1:1 HA WLCs and access points 328 may be local mode access points, in some implementations.

To support the operations of the network, there may be any number of network services and control plane functions 310. For example, functions 310 may include routing topology and network metric collection functions such as, but not limited to, routing protocol exchanges, path computations, monitoring services (e.g., NetFlow or IPFIX exporters), etc. Further examples of functions 310 may include authentication functions, such as by an Identity Services Engine (ISE) or the like, mobility functions such as by a Connected Mobile Experiences (CMX) function or the like, management functions, and/or automation and control functions such as by an APIC-Enterprise Manager (APIC-EM).

During operation, network data collection platform 304 may receive a variety of data feeds that convey collected data 334 from the devices of branch office 306 and campus 308, as well as from network services and network control plane functions 310. Example data feeds may comprise, but are not limited to, management information bases (MIBS) with Simple Network Management Protocol (SNMP)v2, JavaScript Object Notation (JSON) Files (e.g., WSA wireless, etc.), NetFlow/IPFIX records, logs reporting in order to collect rich datasets related to network control planes (e.g., Wi-Fi roaming, join and authentication, routing, QoS, PHY/MAC counters, links/node failures), traffic characteristics, and other such telemetry data regarding the monitored network. As would be appreciated, network data collection platform 304 may receive collected data 334 on a push and/or pull basis, as desired. Network data collection platform 304 may prepare and store the collected data 334 for processing by cloud service 302. In some cases, network data collection platform may also anonymize collected data 334 before providing the anonymized data 336 to cloud service 302.

In some cases, cloud service 302 may include a data mapper and normalizer 314 that receives the collected and/or anonymized data 336 from network data collection platform 304. In turn, data mapper and normalizer 314 may map and normalize the received data into a unified data model for further processing by cloud service 302. For example, data mapper and normalizer 314 may extract certain data features from data 336 for input and analysis by cloud service 302.

In various embodiments, cloud service 302 may include a machine learning (ML)-based analyzer 312 configured to analyze the mapped and normalized data from data mapper and normalizer 314. Generally, analyzer 312 may comprise a power machine learning-based engine that is able to understand the dynamics of the monitored network, as well as to predict behaviors and user experiences, thereby allowing cloud service 302 to identify and remediate potential network issues before they happen.

Machine learning-based analyzer 312 may include any number of machine learning models to perform the techniques herein, such as for cognitive analytics, predictive analysis, and/or trending analytics as follows:
Cognitive Analytics Model(s): The aim of cognitive analytics is to find behavioral patterns in complex and unstructured datasets. For the sake of illustration, analyzer 312 may be able to extract patterns of Wi-Fi roaming in the network and roaming behaviors (e.g., the “stickiness” of clients to APs 320, 328, “ping-pong” clients, the number of visited APs 320, 328, roaming triggers, etc). Analyzer 312 may characterize such patterns by the nature of the device (e.g., device type, OS) according to the place in the network, time of day, routing topology, type of AP/WLC, etc., and potentially correlated with other network metrics (e.g., application, QoS, etc.). In another example, the cognitive analytics model(s) may be configured to extract AP/WLC related patterns such as the number of clients, traffic throughput as a function of time, number of roaming processed, or the like, or even end-device related patterns (e.g., roaming patterns of iPhones, IoT Healthcare devices, etc.).
Predictive Analytics Model(s): These model(s) may be configured to predict user experiences, which is a significant paradigm shift from reactive approaches to network health. For example, in a Wi-Fi network, analyzer 312 may be configured to build predictive models for the joining/roaming time by taking into account a large plurality of parameters/observations (e.g., RF variables, time of day, number of clients, traffic load, DHCP/DNS/Radius time, AP/WLC loads, etc.). From this, analyzer 312 can detect potential network issues before they happen. Furthermore, should abnormal joining time be predicted by analyzer 312, cloud service 312 will be able to identify the major root cause of this predicted condition, thus allowing cloud service 302 to remedy the situation before it occurs. The predictive analytics model(s) of analyzer 312 may also be able to predict other metrics such as the expected throughput for a client using a specific application. In yet another example, the predictive analytics model(s) may predict the user experience for voice/video quality using network variables (e.g., a predicted user rating of 1-5 stars for a given session, etc.), as function of the network state. As would be appreciated, this approach may be far superior to traditional approaches that rely on a mean opinion score (MOS). In contrast, cloud service 302 may use the predicted user experiences from analyzer 312 to provide information to a network administrator or architect in real-time and enable closed loop control over the network by cloud service 302, accordingly. For example, cloud service 302 may signal to a particular type of endpoint node in branch office 306 or campus 308 (e.g., an iPhone, an IoT healthcare device, etc.) that better QoS will be achieved if the device switches to a different AP 320 or 328.
Trending Analytics Model(s): The trending analytics model(s) may include multivariate models that can predict future states of the network, thus separating noise from actual network trends. Such predictions can be used, for example, for purposes of capacity planning and other “what-if” scenarios.

Machine learning-based analyzer 312 may be specifically tailored for use cases in which machine learning is the only viable approach due to the high dimensionality of the dataset and patterns cannot otherwise be understood and learned. For example, finding a pattern so as to predict the actual user experience of a video call, while taking into account the nature of the application, video CODEC parameters, the states of the network (e.g., data rate, RF, etc.), the current observed load on the network, destination being reached, etc., is simply impossible using predefined rules in a rule-based system.

Unfortunately, there is no one-size-fits-all machine learning methodology that is capable of solving all, or even most, use cases. In the field of machine learning, this is referred to as the “No Free Lunch” theorem. Accordingly, analyzer 312 may rely on a set of machine learning processes that work in conjunction with one another and, when assembled, operate as a multi-layered kernel. This allows network assurance system 300 to operate in real-time and constantly learn and adapt to new network conditions and traffic characteristics. In other words, not only can system 300 compute complex patterns in highly dimensional spaces for prediction or behavioral analysis, but system 300 may constantly evolve according to the captured data/observations from the network.

Cloud service 302 may also include output and visualization interface 318 configured to provide sensory data to a network administrator or other user via one or more user interface devices (e.g., an electronic display, a keypad, a speaker, etc.). For example, interface 318 may present data indicative of the state of the monitored network, current or predicted issues in the network (e.g., the violation of a defined rule, etc.), insights or suggestions regarding a given condition or issue in the network, etc. Cloud service 302 may also receive input parameters from the user via interface 318 that control the operation of system 300 and/or the monitored network itself. For example, interface 318 may receive an instruction or other indication to adjust/retrain one of the models of analyzer 312 from interface 318 (e.g., the user deems an alert/rule violation as a false positive).

In various embodiments, cloud service 302 may further include an automation and feedback controller 316 that provides closed-loop control instructions 338 back to the various devices in the monitored network. For example, based on the predictions by analyzer 312, the evaluation of any predefined health status rules by cloud service 302, and/or input from an administrator or other user via input 318, controller 316 may instruct an endpoint client device, networking device in branch office 306 or campus 308, or a network service or control plane function 310, to adjust its operations (e.g., by signaling an endpoint to use a particular AP 320 or 328, etc.).

As noted above, cloud service 302 offers a critical advantage over on-premises solutions, as it can leverage a large number of datasets from different monitored networks. However, the various monitored networks may be in different industries such as, but not limited to, catering, retail, healthcare, universities, or the sports industry. Moreover, even for a given network, its dataset may have a large diversity of telemetric data (e.g., a healthcare provider may have both offices with very regular patterns and a hospital area with always-on devices and irregular user behaviors). Even two campuses or two hospitals may have very different traffic profiles, network topologies, etc., leading to non-comparable networks. As a result, it may sometimes be more useful to build models per type of network entity (e.g., APs, switches, routers, controllers) rather than per type of network use (e.g., retail, healthcare, financial, university, etc.).

### Peer Comparison by a Network Assurance Service Using Network Entity Clusters

The techniques herein introduce a series of mechanisms that allow for the tailoring of machine learning-based behavioral models per network deployment. In some aspects, the behavioral models may be specifically targeted for each entity of the network, allowing for superior predictions over classical approaches. More specifically, these models may be trained using training data that is relevant to those entities, thanks to the data aggregation, clustering and generation mechanisms introduced herein.

Specifically, according to one or more embodiments of the disclosure as described in detail below, a network assurance service that monitors a plurality of networks obtains characteristic data regarding network entities deployed in the plurality of networks. The network assurance service assigns the network entities to entity clusters by applying a clustering mechanism to the characteristic data regarding the network entities. The network assurance service generates, for each of the entity clusters, a training dataset using the characteristic data for the network entities assigned to that cluster. The network assurance service uses, for each of the entity clusters, the training datasets for an entity cluster to train a machine learning-based model that models the behavior of that entity cluster.

Illustratively, the techniques described herein may be performed by hardware, software, and/or firmware, such as in accordance with the network assurance process 248, which may include computer executable instructions executed by the processor 220 (or independent processor of interfaces 210) to perform functions relating to the techniques described herein.

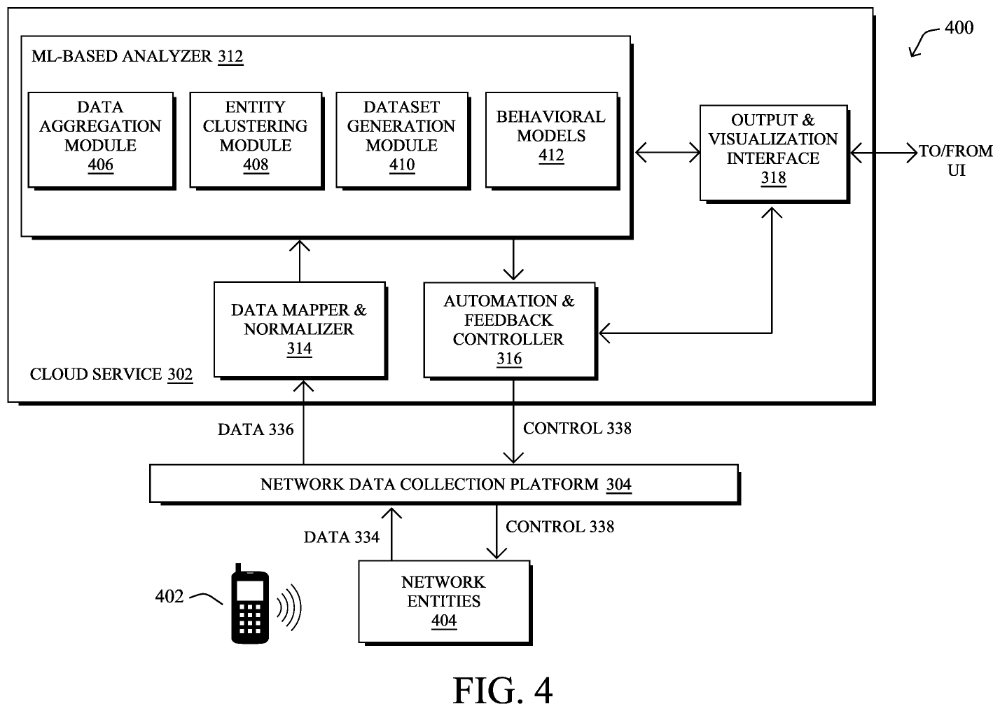

Operationally, FIG. 4 illustrates an example architecture 400 for performing the dynamic inspection of networking dependencies to enhance anomaly detection models in a network assurance service, according to various embodiments. At the core of architecture 400 may be the following components: a data aggregation module 406, an entity clustering module 408, a dataset generation module 410, and/or behavioral models 412. In some implementations, the components 406-412 of architecture 400 may be implemented within a network assurance system, such as system 300 shown in FIG. 3. Accordingly, the components 406-412 of architecture 400 shown may be implemented as part of cloud service 302 (e.g., as part of machine learning-based analyzer 312 and/or output and visualization interface 318), as part of network data collection platform 304, and/or on one or more network elements/entities 404 that communicate with one or more client devices 402 within the monitored network itself. Further, these components 406-412 may be implemented in a distributed manner or implemented as its own stand-alone service, either as part of the local network under observation or as a remote service. In addition, the functionalities of the components of architecture 400 may be combined, omitted, or implemented as part of other processes, as desired.

In various embodiments, architecture 400 may include a data aggregation module 406, which is responsible for generating an entity descriptor for the network entities 404. For each network entity 404, such as an AP, switch, router, AP controller, data aggregation module 406 may obtain three types of characteristic data: entity-related data, client-related data, and deployment-related data. The entity-related data consist in high-level statistics such as average, standard deviation, skewness or kurtosis of Key Performance Indicators (KPIs) of the entity 404. For instance, radios in a Wi-Fi network may be characterized by KPIs such as the AP type, antennas, outdoor/indoor deployment, height of AP, client count, traffic, interference, channel utilization, etc. As another example for the WAN, such KPI could be average/min/max link utilization, queues congestion level, average/min/max packet loss and jitter, average number of hops along any pair of routers in the WAN, link reliability, or the like. As would be appreciated, the characteristic data for a given network entity 404 may be received from network data collection platform 304 on a push or pull basis.

Client-related data consist of the type of client 402 connected to the entities 404 (e.g., Android device, printer, IoT device, etc.) and/or the type of application used by the clients, or the physical layer characteristics such as received signal strength indicator (RSSI), signal-to-noise ratio (SNR), or data rate. This may be of importance because media or cloud applications have different requirements from a network perspective than web browsing, for instance.

Finally, data aggregation module 406 may also obtain data about the type of deployment in which a network entity 404 is located. For example, in the case of wireless networks, the deployment data for a given entity 404 may indicate the number and density of radios and APs in the monitored network, the variability in client count, the mobility pattern that is seen in the network, AP groups, the radio resource management (RRM) profile configured, the number of SSIDs enabled, or the like. Another source of information related to the deployment may be the traffic profile in the network, such as the amount of traffic, level of periodicity, ratio of real-time vs. non real-time application per user, IoT vs non-IoT traffic ratio, etc.

Once data aggregation module 406 has obtained the characteristic data regarding a network entity 404, it may aggregate this information into a d-dimensional numerical vector that represents the entity. Data aggregation module 404 may repeat this process for any and all network entities 404 across any number of networks monitored by service 302.

Also as shown, architecture 400 may include an entity clustering module 408 which is responsible for generating clusters of entities 404 across a plurality of networks monitored by service 302. During execution, entity clustering module 408 uses the output of data aggregation module 406 (e.g., the d-dimensional vectors), to create K-number of clusters using to the provided d-dimensional numerical vectors for all the network entities 404 in the dataset. Every entity is then assigned to its corresponding cluster by entity clustering module 408. If a new network or network entity 404 is added to the list monitored by service 302, entity clustering module 408 may map the new entities to a pre-existing entity cluster.

In a first embodiment, for network for which service 302 has obtained at least a few days of entity characteristic data, entity clustering module 408 may perform the clustering once per entity 404 and in a fixed manner. Here, entity clustering module 408 may use K-means clustering. However, entity clustering module 408 may use any number of other clustering mechanisms, such as, but not limited to, Spectral clustering, DBSCAN, or Gaussian Mixture Models. In the case of K-means, entity clustering module 408 may pre-set the number of resulting clusters K. To do so, entity clustering module 408 may employ a mechanism such as the Akaike Information Criterion (AIC) or the Bayesian Information Criterion (BIC).

In the second embodiment, for monitored networks in which service 302 has access to a greater amount of entity characteristic data (e.g., several weeks, etc.), entity clustering module 408 may perform the clustering on the aggregated d-dimensional vector for each entity 404, as in the previous embodiment, but the cluster assignment is achieve every time step T, hence changing over time.

In another embodiment, for networks for which service 302 has obtained entity characteristic data for an even greater period of time (e.g., several months or longer), entity clustering module 408 may perform the clustering on time series. In particular, entity clustering module 408 may attempt to cluster t-sequences of the d-dimensional vectors. To do so, entity clustering module 408 may first compute a distance matrix between all the network entities 404 from all the monitored networks. While the Euclidean distance was used in the previous embodiment, entity clustering module 408 may instead use a temporal based distance in this embodiment, such as, but not limited to, Dynamic Time Warping or Global Alignment Kernel distance. Then, entity clustering module 408 may perform hierarchical clustering, in order to group time series into K clusters. Examples of hierarchical clustering that entity clustering module 408 may use include, but are not limited to, Single-linkage Clustering or Complete-Linkage Clustering.

In another embodiment, entity clustering module 408 may readjust the number of clusters on a regular basis, so as to determine whether the number of clusters should be increased or decreased. For example, entity clustering module 408 may use an objective function that seeks to cap the number of outliers found out for a given value of K. In such cases, entity clustering module 408 may use the previous clustering information, such as cluster centroids, to jump start the cluster formation, allowing the clustering to converge faster.

Also as shown, another component of architecture 400 may be dataset generation module 410 which relies on the clustering assignment performed by entity clustering module 408. More specifically, dataset generation module 410 is responsible for generating a tailored training set using the multi-network dataset for each of the K clusters. Once the generated dataset is available, dataset generation module 410 may also trigger a model training for each generated dataset, e.g., for each cluster of entities, to train behavioral models 412. Once trained, analyzer 312 may use the corresponding behavioral model 412 for a given entity 404 to assess the behavior of the entity (e.g., to identify abnormal entity behavior, etc.) and raise alerts via output and visualization interface 318.

In one embodiment, dataset generation module 410 may gather all the data available for the selected cluster in order to compute a custom model 412. However, this approach has a major drawback, as some clusters may have very little data, thus leading to poor machine learning models.

In another embodiment, dataset generation module 410 may use sampling methods, to generate custom training data set for each of the K clusters from entity clustering module 408. To this end, dataset generation module 410 can leverage a number of different sampling approaches such as, but not limited to, Markov Chain Monte Carlo (MCM) via the Metropolis-Hasting algorithm and Gibbs sampling, or via Diversity Based sampling.

In another embodiment, dataset generation module 410 may train a Generative Adversarial Network (GAN) for each of the K cluster from entity clustering module 408. In general, a GAN is a form of unsupervised learning that includes two neural networks that compete with each other. The first neural network of the GAN, also called the generator, generates samples while the other neural network, called the discriminator, evaluates them. The generative network objective is to dupe the generative network, while the objective of the discriminative network is to distinguish real samples (i.e., coming from the training set) from synthetic samples (i.e., artificially constructed by the generator). The optimization problem may be represented as follows:

$${min}_{θ} {max}_{φ} {𝔼}_{{p}^{*} ( x )} [ log D ( x ; φ ) ] + {𝔼}_{p ( x ; θ )} [ log ( 1 - D ( x ; φ ) ) ]$$

where p*(x) is the true data distribution, x is the data input, θ the generative network parameters, and ϕ the discriminative network parameters.

One of the key features of using a GAN is that a GAN can generate artificial/synthetic datasets that retain the same statistical properties, while providing privacy guarantees since no data from a first network monitored network has been used to train a model for a second monitored network. In other words, dataset generation module 410 may use a GAN on the characteristic data associated with the entity clusters formed by entity clustering module 408, to generate synthetic training data that has the same statistical properties as the characteristic data. In turn, dataset generation module 410 may trigger model training using the synthetic training dataset, to train a behavioral model 412.

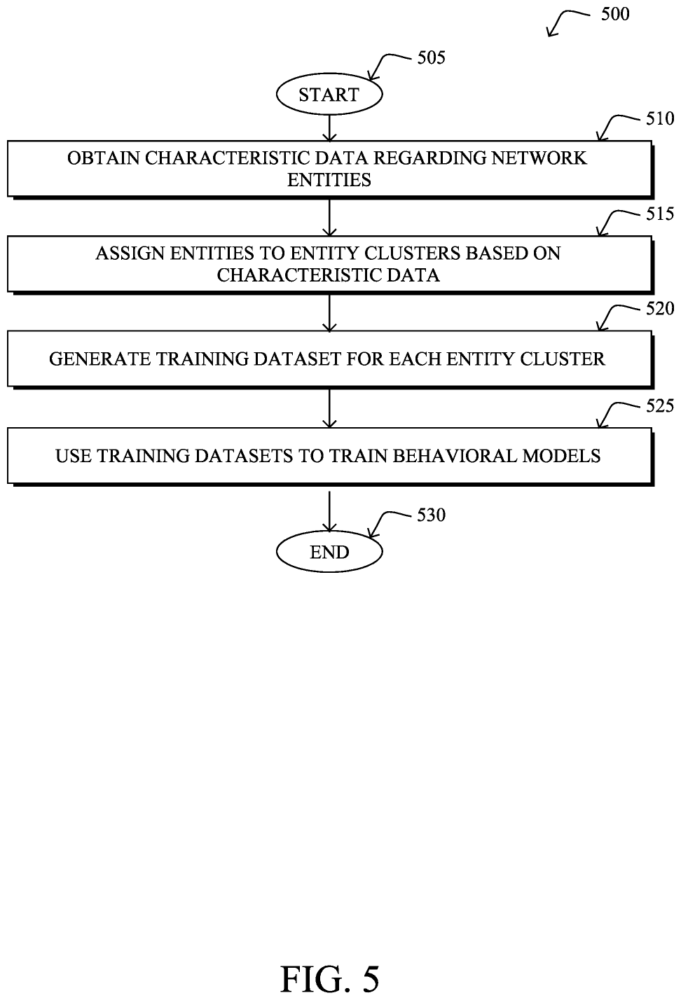

FIG. 5 illustrates an example simplified procedure for using network entity clusters to train behavioral models for a network assurance service, in accordance with one or more embodiments described herein. For example, a non-generic, specifically configured device (e.g., device 200) may perform procedure 500 by executing stored instructions (e.g., process 248) to provide a network assurance service to a plurality of monitored networks. The procedure 500 may start at step 505, and continues to step 510, where, as described in greater detail above, characteristic data regarding network entities deployed in the plurality of networks. Such network entities may include wireless access points, network switches, network routers, or wireless access point controllers, or the like. In various embodiments, the characteristic data may include performance metrics for the entities, data regarding clients connected to the entities (e.g., application information, etc.), and network deployment data regarding the network in which the entity is deployed.

At step 515, as detailed above, the network assurance service may assign the network entities to entity clusters by applying a clustering mechanism to the characteristic data regarding the network entities. In some embodiments, the clustering mechanism may be a k-means clustering approach and the number of clusters, k, may be controlled using an Akaike Information Criterion (AIC) or Bayesian Information Criterion (BIC). In further embodiments, the service may assign the entities to clusters by computing a distance matrix between the entities, based on a temporal-based distance measure between time series of the characteristic data for the entities, and then using the distance matrix to apply hierarchical clustering to the entities, to group the time series into a predefined number of entity clusters.

At step 520, the network assurance service may generate, for each of the entity clusters, a training dataset using the characteristic data for the network entities assigned to that cluster, as described in greater detail above. In some embodiments, the service may do so by sampling from the characteristic data for the network entities using a Markov Chain Monte Carlo (MCM)-based approach. In further embodiments, the service may train a generative adversarial network (GAN) using the characteristic data for the networking entities assigned to the cluster. Once trained, the GAN generates synthetic characteristic data for inclusion in the training dataset for that cluster.

At step 525, as detailed above, the network assurance service may use, for each of the entity clusters, the training dataset for an entity cluster to train a machine learning-based model that models the behavior of that entity cluster. As would be appreciated, this allows a given behavioral model to be trained using the characteristics of similar network entities across different networks, regardless of the industry or operator associated with the network. Procedure 500 then ends at step 530.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for using network entity clusters in a network assurance service, it is to be understood that various other adaptations and modifications may be made within the spirit and scope of the embodiments herein. For example, while certain embodiments are described herein with respect to using certain models for purposes of anomaly detection, the models are not limited as such and may be used for other functions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
obtaining, by a network assurance service that monitors a plurality of networks, characteristic data regarding network entities deployed in the plurality of networks;
assigning, by the network assurance service, the network entities to entity clusters by applying a clustering mechanism to the characteristic data regarding the network entities;
generating, by the network assurance service and for each of the entity clusters, a training dataset using the characteristic data for the network entities assigned to that cluster; and
using, by the network assurance service and for each of the entity clusters, the training dataset for an entity cluster to train a machine learning-based model that models the behavior of that entity cluster.

2. The method as in claim 1, wherein the network entities comprise one or more of: wireless access points, network switches, network routers, or wireless access point controllers.

3. The method as in claim 1, further comprising:
using, by the network assurance service, the trained models to evaluate the behavior of the network entities in the plurality of monitored networks.

4. The method as in claim 1, wherein the characteristic data regarding the network entities comprises: performance metrics for the entities, data regarding clients connected to the entities, and network deployment data regarding the network in which the entity is deployed.

5. The method as in claim 1, wherein generating, by the network assurance service and for each of the entity clusters, a training dataset using the characteristic data for the network entities assigned to that cluster comprises:
training a generative adversarial network (GAN) using the characteristic data for the networking entities assigned to the cluster, wherein the GAN generates synthetic characteristic data for inclusion in the training dataset for that cluster.

6. The method as in claim 1, wherein generating, by the network assurance service and for each of the entity clusters, a training dataset using the characteristic data for the network entities assigned to that cluster comprises:
sampling from the characteristic data for the network entities using a Markov Chain Monte Carlo (MCM)-based approach.

7. The method as in claim 1, wherein assigning the network entities to entity clusters by applying a clustering mechanism to the characteristic data regarding the network entities comprises:
computing a distance matrix between the entities, based on a temporal-based distance measure between time series of the characteristic data; and
using the distance matrix to apply hierarchical clustering to the entities, to group the time series into a predefined number of entity clusters.

8. The method as in claim 1, wherein assigning the network entities to entity clusters by applying a clustering mechanism to the characteristic data regarding the network entities comprises:
periodically re-clustering the network entities.

9. The method as in claim 1, wherein assigning the network entities to entity clusters by applying a clustering mechanism to the characteristic data regarding the network entities comprises:
using an Akaike Information Criterion (AIC) or Bayesian Information Criterion (BIC) to control the number of clusters.

10. An apparatus, comprising:
one or more network interfaces to communicate with a network;
a processor coupled to the network interfaces and configured to execute one or more processes; and
a memory configured to store a process executable by the processor, the process when executed configured to:
obtain, from a plurality of monitored networks, characteristic data regarding network entities deployed in the plurality of networks;
assign the network entities to entity clusters by applying a clustering mechanism to the characteristic data regarding the network entities;
generate and for each of the entity clusters, a training dataset using the characteristic data for the network entities assigned to that cluster; and
use, for each of the entity clusters, the training dataset for an entity cluster to train a machine learning-based model that models the behavior of that entity is cluster.

11. The apparatus as in claim 10, wherein the network entities comprise one or more of: wireless access points, network switches, network routers, or wireless access point controllers.

12. The apparatus as in claim 10, wherein the process when executed is further configured to:
use the trained models to evaluate the behavior of the network entities in the plurality of monitored networks.

13. The apparatus as in claim 10, wherein the characteristic data regarding the network entities comprises: performance metrics for the entities, data regarding clients connected to the entities, and network deployment data regarding the network in which the entity is deployed.

14. The apparatus as in claim 10, wherein the apparatus generates, for each of the entity clusters, a training dataset using the characteristic data for the network entities assigned to that cluster by:
training a generative adversarial network (GAN) using the characteristic data for the networking entities assigned to the cluster, wherein the GAN generates synthetic characteristic data for inclusion in the training dataset for that cluster.

15. The apparatus as in claim 10, wherein the apparatus generates, for each of the entity clusters, a training dataset using the characteristic data for the network entities assigned to that cluster by:
sampling from the characteristic data for the network entities using a Markov Chain Monte Carlo (MCM)-based approach.

16. The apparatus as in claim 10, wherein the apparatus assigns the network entities to entity clusters by applying a clustering mechanism to the characteristic data regarding the network entities by:
computing a distance matrix between the entities, based on a temporal-based distance measure between time series of the characteristic data; and
using the distance matrix to apply hierarchical clustering to the entities, to group the time series into a predefined number of entity clusters.

17. The apparatus as in claim 10, wherein the apparatus assigns the network entities to entity clusters by applying a clustering mechanism to the characteristic data regarding the network entities by:
periodically re-clustering the network entities.

18. The apparatus as in claim 10, wherein the apparatus assigns the network entities to entity clusters by applying a clustering mechanism to the characteristic data regarding the network entities by:
using an Akaike Information Criterion (AIC) or Bayesian Information Criterion (BIC) to control the number of clusters.

19. A tangible, non-transitory, computer-readable medium storing program instructions that cause a network assurance service that monitors a plurality of networks to execute a process comprising:
obtaining, by the network assurance service, characteristic data regarding network entities deployed in the plurality of networks;
assigning, by the network assurance service, the network entities to entity clusters by applying a clustering mechanism to the characteristic data regarding the network entities;
generating, by the network assurance service and for each of the entity clusters, a training dataset using the characteristic data for the network entities assigned to that cluster; and
using, by the network assurance service and for each of the entity clusters, the training dataset for an entity cluster to train a machine learning-based model that models the behavior of that entity cluster.

20. The computer-readable medium as in claim 19, wherein generating, by the network assurance service and for each of the entity clusters, a training dataset using the characteristic data for the network entities assigned to that cluster comprises:
training a generative adversarial network (GAN) using the characteristic data for the networking entities assigned to the cluster, wherein the GAN generates synthetic characteristic data for inclusion in the training dataset for that cluster.
